(19) United States
(12) Patent Application Publication
(10) Pub. No.: US 2026/0269673 A1
(43) Pub. Date: Sep. 10, 2026

(54) ELECTRIC MOTOR, IN PARTICULAR RADIATOR FAN MOTOR

(71) Applicant: BROSE FAHRZEUGTEILE SE & CO. KOMMANDITGESELLSCHAFT, WÜRZBURG, Würzburg (DE)

(72) Inventors: Martin PFISTER, Wiesentheid (DE); Lazar STOJNIC, Belgrade (RS); Miroslav BORZANOVIC, Belgrade (RS)

(21) Appl. No.: 19/159,225

(22) PCT Filed: Feb. 21, 2024
(86) PCT No.: PCT/EP2024/054337

§ 371 Date: Aug. 22, 2025

(30) Foreign Application Priority Data
Feb. 22, 2023 (DE) 102023201624.9

(51) Int. Cl. H02K 3/52; H02K 11/40

(52) U.S. Cl. CPC H02K 3/522; H02K 11/40; H02K 2203/09

(57) ABSTRACT

An electric motor, in particular a radiator fan motor of a motor vehicle, having a motor support, a stator and an electric plug connection, wherein the stator has a stator main body with radially oriented stator teeth and a stator or rotary field winding with winding ends, wherein the plug connection is arranged between the stator main body and the motor support, and wherein the winding ends are directly connected to connection contacts of the plug connection

The invention relates to a brushless electric motor, in particular a radiator fan motor of a motor vehicle.

Such an electric motor typically comprises a rotor mounted so as to be rotatable relative to a stationary stator. In a brushless electric motor, the stator is provided with a stator or rotary field winding, which generates a rotating magnetic field when it is supplied with an alternating current. The rotor is typically equipped with permanent magnets that generate a rotor magnetic field that interacts with the rotating field of the stator.

In a brushless electric motor, the alternating current used to supply the stator winding is usually generated by an inverter. In smaller electric motors, this inverter, together with associated control electronics, is often housed in an electronics compartment that is integrated into the electric motor or its motor housing. In addition, the stator winding should be reliably electrically insulated from a stator main body, which is often constructed as a laminated core made of stacked laminations.

A brushless electric motor known from EP 2 852 035 B1 and designed as an internal rotor (motor), in particular a radiator fan motor, comprises a rotor mounted so as to be rotatable relative to a stator, and a motor support which contains an electronics compartment which is sealed or can be sealed by an electronics compartment cover for accommodating inverter electronics. These comprise a circuit board equipped with passive and active components, as well as with power semiconductors connected in a bridge circuit.

The object of the invention is to provide an electric motor of the aforementioned type with an integrated connection, in particular for contact with external motor electronics.

This object is achieved according to the invention by the features of claim 1. Advantageous variants, embodiments, and further developments are the subject matter of the dependent claims.

The brushless electric motor, which is in particular intended and configured as a radiator fan motor of a motor vehicle, has a motor support (a motor support plate), in particular a plate-like or plate-shaped motor support, and a stator fastened to the motor support with a stator or rotary field winding, and a plug or connector for in particular direct connection to winding ends of the stator or rotary field winding. In other words, the winding ends of the stator or rotary field winding are directly connected to the connection contacts of the plug connection for in particular multiphase current supply thereof.

The plug connection is intended or designed for connection to (motor) electronics arranged outside the electric motor, for example for three-phase current supply to the stator or rotary field winding. For example, the connection contacts of the plug connection are designed as clamp contacts or welded contacts, or as combined clamp-welded contacts for electrical and mechanical connection with conductor cores of a connection cable.

The electric motor is appropriately an internal rotor motor, the stator of which is concentric to the motor axis (motor rotation axis) and surrounds a rotor, in particular one having permanent magnets. In the embodiment as an internal rotor motor, the rotor located inside the stator is mounted so that it can rotate around the motor rotation axis. The electric motor can also be designed as an external rotor motor, the stator of which is concentric to the motor axis (motor rotation axis) and is rotated during motor operation by a pot-shaped rotor with permanent magnets on the inner wall.

Appropriately, the stator has an annular stator main body, preferably forming a circumferential annular edge, with radially oriented stator teeth, in particular radially inwardly directed stator teeth. Particularly advantageously, the stator main body is surrounded by a plastic jacket, in particular is encapsulated with a plastic coating for electrical insulation of the stator or rotary field winding.

The stator also has the stator or rotary field winding with winding ends for multiphase, in particular three-phase, current supply to the stator or rotary field winding. The stator or rotary field winding is formed in particular from coils which are arranged on the stator teeth. The coils are at least partially interconnected and/or connected to each other, for example, for a star or delta connection.

The plug connection is located between the stator main body and the motor support. Preferably, the plug connection is clamped between the stator main body and the motor support. In other words, the fixing or mounting of the plug connection on the electric motor is realized by a clamp connection between the motor support and the stator. In this case, the plug connection is preferably supported on the stator or on the stator main body and fixed by means of the motor support when the latter and the stator or the stator main body are connected to each other. The connection between the motor support and the stator or its stator main body is produced or can be produced, for example, by means of staking pins on the stator-side plastic coating, which are guided through fixing or staking openings in the motor support and subsequently deformed.

In an advantageous embodiment, the stator main body, in particular at its circumferential annular edge, has a number of joining contours which correspond to joining elements of the plug connection to produce a joining connection. The stator-side joining contours may be recesses in the plastic coating, which are designed, for example, in an electric motor with integrated electronics, for sealing elements of winding ends of the stator or rotary field winding.

Appropriately, the plug connection has a connection housing with the connection contacts for the winding ends of the stator or rotary field winding. Particularly preferably, the connection contacts of the plug connection are designed as busbars, in particular hook-shaped busbars. The plug connection may be designed as a plug or as a socket with a circumferentially closed connection or cover cap in order to cover the connection contacts, for example, in a finger-safe manner. Alternatively, the plug contact may also be designed without a cover cap enclosing the connection contacts. The plug connection may also be generally referred to as a contact unit, in particular in this embodiment.

According to an advantageous further development, the plug connection has a ground or earthing contact, in particular in the form of a busbar. This is or will be brought into contact with the motor support, particularly during the assembly of the stator or of the stator main body on or with the motor support.

Expediently, the joining elements of the plug connection are molded onto the connection housing. Preferably, the plug connection has a cover cap for covering the connection housing and/or for securing a potting material with which the plug connection is provided. The potting material serves to reliably seal the connection-side contacts or their contact connections with the winding ends of the stator or rotary field winding.

Particularly preferably, the plug connection is arranged or positioned at an acute angle relative to a plane parallel to the stator and/or the motor support, and/or at an angle of less than 90° and greater than 45° to a motor rotation axis.

An embodiment of the invention is explained in more detail below with reference to a drawing. In the figures:

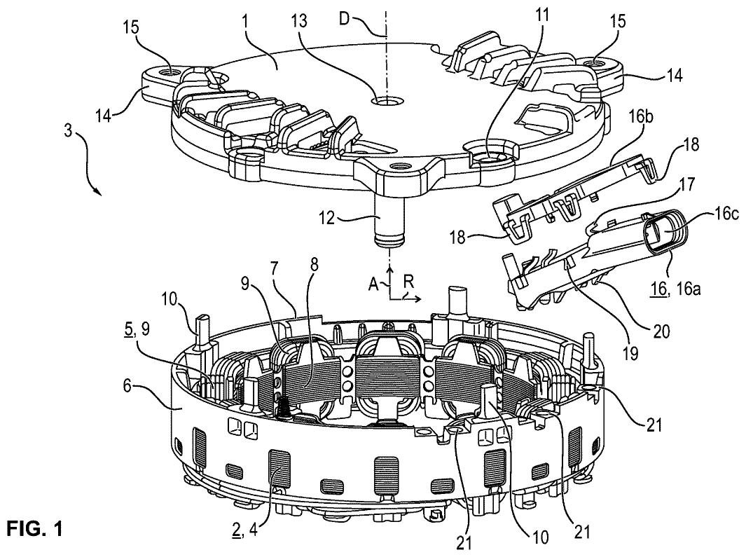

FIG. 1 is an exploded view of a brushless electric motor in an internal rotor design with a stator and a plate-like motor support, and with a plug connection having connection contacts for winding ends of a stator winding (rotary field winding),

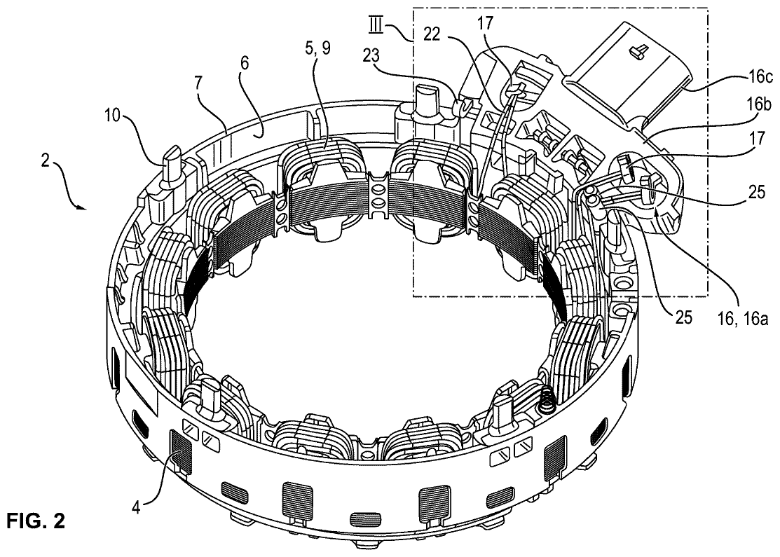

FIG. 2 is a perspective view of the stator with a plug connection mounted on a circumferential edge of an encapsulated stator support and contacted with the winding ends of the stator winding (rotary field winding),

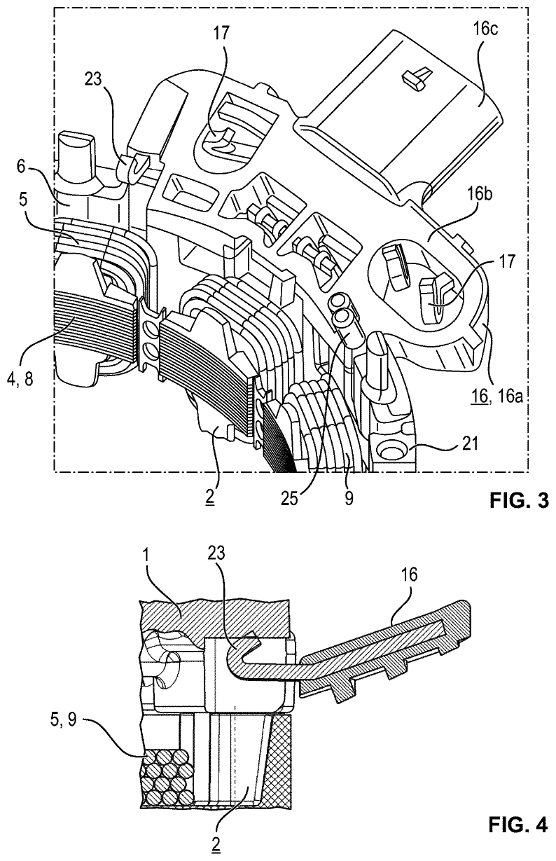

FIG. 3 is a section of FIG. 2 with the plug connection without contact with the winding ends of the stator winding (rotary field winding),

FIG. 4 is a sectional view of the connection between the motor support and the stator in the region of a ground or earth contact,

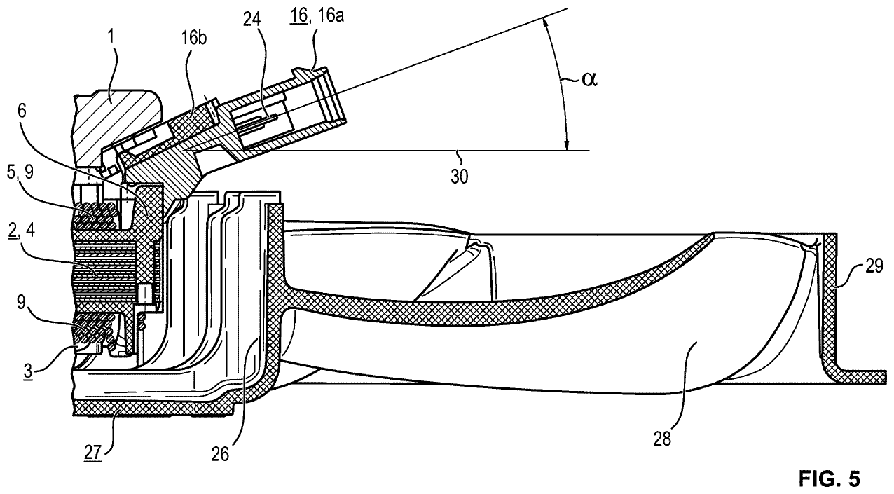

FIG. 5 is a sectional view of the electric motor connected to a pot-shaped fan wheel in the region of the plug connection, and

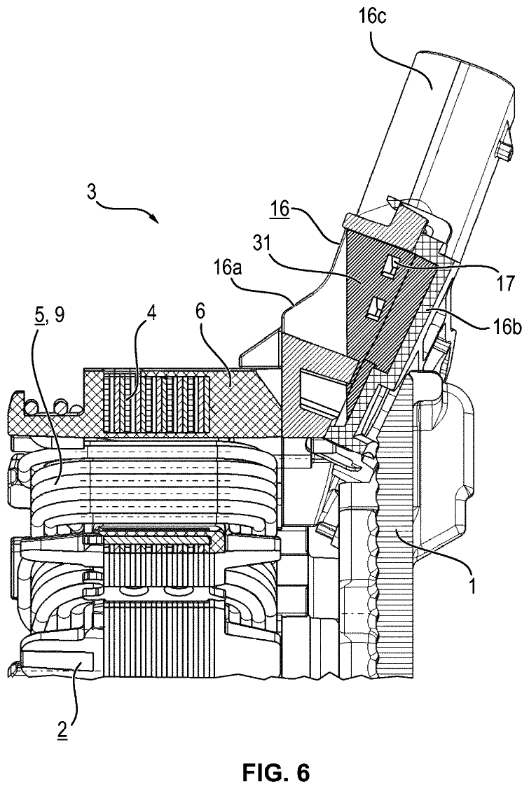

FIG. 6 is a sectional view of the electric motor with the plug connection provided with a potting compound.

Parts and dimensions corresponding to one another are provided with the same reference numbers in all figures. Designations such as axial and radial are related to a motor axis (rotation axis) D indicated in FIG. 1 and to the axial and radial directions A and R shown therein.

FIG. 1 shows an exploded view of a plate-shaped motor support 1 and a stator 2 of an electric motor 3, which preferably serves as a drive for a radiator fan of a motor vehicle. The brushless electric motor 3 is designed, for example, as an internal rotor motor, the rotor of which, not shown here and provided with permanent magnets, is arranged within the stator 2 and is mounted so as to be rotatable about the rotation axis D. The motor support 1 is preferably an aluminum die-cast part.

The stator 2 has a stator main body 4 and a stator or rotary field winding 5. The stator main body 4, which is preferably formed from a number of laminations stacked to form a laminated core, is encapsulated with a plastic jacket 6. This is used in particular for winding or coil insulation of the stator or rotary field winding 5. The stator main body 4 is annular-shaped or hollow cylindrical and has a circumferential annular edge 7. The stator 2 or its stator main body 4 has stator teeth 8 directed radially inward (in radial direction R), on which coils 9 forming the stator or rotary field winding 5 are arranged (wound).

In the region of or on the annular edge 7, a number of staking pins 10 are formed on the plastic jacket 6, which extend axially (in axial direction A). The staking pins 10 correspond to the fixing or staking openings 11 of the motor support 1. In the assembly or joining state of the stator 2 with the motor support 1, the stator-side staking pins 10 pass through the support-side staking openings 11 in order to be subsequently staked. This fixes the stator 2 to the motor support 1.

The motor support 1 has, on its support side assigned to or facing the stator 2, a rigid axis of rotation in the form of an axle bolt 12, which is received in a corresponding bolt receptacle 13 of the motor support 1 in a rotationally fixed manner, for example by being potted or pressed into it. The axle bolt 12 forms the rotation or motor axis D of the electric motor 3 or the rotor. The motor support 1 also has screw or mounting tabs 14 with fastening openings or holes 15, in particular for screw fastening of the motor support 1 or the electric motor 3. The electric motor 3 and thus the fan are fastened to the motor vehicle or to a body part, for example, as a screw fastening, via the screw or mounting tabs 14 which project radially beyond the outer circumference of the motor support 1.

The electric motor 3 has a plug connection 16, also referred to below as a contact unit. The plug connection 16 may be designed as a plug or preferably as a socket with a circumferentially closed connection cap, or also as a contact unit. The plug connection 16 has connection contacts 17, the number of which appropriately corresponds to the number of phases of the electric motor 3. The plug connection 16 has a connection housing 16a with connection contacts 17 for the stator or rotary field winding 5 accommodated therein. The plug connection 16 has a housing cap or a housing cover 16b with which the connection housing 16a can be at least partially covered or closed. For this purpose, a number of joining elements, designed in the embodiment as latching tabs 18, are integrally formed on the housing cover 16b, and corresponding joining contours in the form of latching pins 19 are formed on the connection housing 16.

In the assembled state, the plug connection 16 is supported on the stator 2 and preferably on the annular edge 7 of the stator main body 4. In the assembled state, with the motor support 1 joined to the stator 2, the plug connection 16 is arranged between the motor support and the stator 2, preferably clamped. The plug connection 16 has, for example, rib-like joining elements or joining pins 20. These correspond to joining contours 21 of the stator main body 4 in the region of the annular edge 7, in particular in the form of axial recesses. When the plug connection 16 is placed on the annular edge 7 of the stator 2 or its stator main body 4, the connection-side joining elements or joining pins 20 engage in the stator-side joining contours or recesses 21. As a result, the plug connection 16 is arranged in its intended position and is preferably already secured to the stator 2.

As can be seen comparatively clearly from FIGS. 2 and 3, the connection contacts 17 of the plug connection 16 serve, in particular, for direct connection to winding ends 22 of the stator or rotary field winding 5, which are designed, for example, as connecting wire pairs. These connection contacts 17 of the plug connection 16 are designed as hook-shaped busbars, so that the winding ends 22 or connecting wire pairs of the stator or rotary field winding 5 can be inserted therein and contacted by clamping, and, for example, additionally contacted by welding. The plug connection 16 has a busbar-like ground or earthing contact 23. This is or will be brought into contact with the motor support 1 during the assembly of the stator 2, as can be seen from FIG. 4.

The plug connection 16 is provided for connection to a (motor) electronics arranged outside the electric motor 3, for example, for three-phase current supply to the stator or rotary field winding 5. For example, the connection contacts 17 of the plug connection 16 are designed as welded contacts for electrical and mechanical connection with conductor cores of a connection cable (not shown).

In the embodiment of the plug connection 16 as a socket, the connection housing 16a has a cover or socket cap 16c, which encloses, in particular covers or encloses in a finger-safe manner, connection pins or contact connections 24 (FIG. 5) of the plug connection 16, which are not visible here. In this embodiment, the plug connection 16 serves to accommodate a connection plug (not shown) which, together with the connection cable, serves to carry current to the stator or rotary field winding 5 via its winding ends 22, which are in contact with the connection contacts 17 of the plug connection 16.

To guide the winding ends 22 of the stator or rotary field winding 5, axial guide domes or pins 25 are integrally formed on the plastic jacket (plastic coating) 6 of the stator 2 at its annular edge 7. At these, the winding ends 22 can be deflected, separated from one another and/or spaced apart from one another, and guided to the corresponding connection contacts 17 of the plug connection 16.

FIG. 5 shows the electric motor 3 in its preferred application as a radiator fan drive. The electric motor 3 with the stator 2 mounted on the motor support 1 and with the plug connection 16 fixed between the latter at the annular edge 7, and the motor support 1 is mounted in a pot-shaped fan hub 26 of a fan wheel 27. A number of fan blades 28 are integrally formed circumferentially on the fan hub 26, which are connected to an outer ring 29 on the blade end side, in particular integrally formed on the latter. It can be seen that the plug connection 16 is inclined at an acute angle a relative to a plane 30 parallel to the plane of the motor support 1 or the stator 2, or is positioned at an angle relative to the motor support 1. In the embodiment, the angle a is approximately 20°.

FIG. 6 shows an embodiment of the plug connection 16 with a potting compound or potting material 31, which is filled or introduced into the connection housing 16a and serves to seal the plug connection 16. The potting material 31 is provided in the region of the connection contacts 17 of the plug connection 16 and is secured by means of the housing cap or cover cap 16b. The potting material 31 thus serves to reliably seal the connection-side contacts 17 or their contact connections with the winding ends 22 of the stator or rotary field winding 5.

In summary, the invention relates to an electric motor 3, in particular a radiator fan motor of a motor vehicle, having a motor support 1, a stator 2 and an electric plug connection 16, wherein the stator 2 has a stator or rotary field winding 5 with winding ends 22, wherein the plug connection 16 is arranged, preferably clamped, between the stator 5 or a stator main body 4 and the motor support 1, and wherein the winding ends 22 are directly connected to connection contacts 17 of the plug connection 16.

The claimed invention is not restricted to the embodiments described above. Rather, other variants of the invention can likewise be derived therefrom by the person skilled in the art within the scope of the disclosed claims, without departing from the subject matter of the claimed invention. In particular, all individual features described in connection with the various embodiments can also be combined with one another in other ways within the scope of the disclosed claims, without departing from the subject matter of the claimed invention.

In addition, the described solution can be used not only in the specific application case described, but also in a similar design in other motor vehicle applications, such as door and tailgate systems, window regulators, adjustable seat and interior systems, and electric drives.

### LIST OF REFERENCE NUMBERS

1 motor support/support plate
2 stator
3 electric motor
4 stator main body
5 stator/rotary field winding
6 plastic jacket
7 annular edge
8 stator tooth
9 coil
10 staking pin
11 joining/staking opening
12 axle bolt
13 bolt receptacle
14 screw tab/mounting tab
15 fastening opening/fastening hole
16 plug connection/contact unit
16a connection housing
16b housing cap/housing cover
16c socket cap
17 connection contact
18 joining element/latching tab
19 joining contour/latching pin
20 joining element/joining pin
21 joining contour/recess
22 winding end
23 ground/earthing contact
24 connection pin/contact connection
25 guide dome/guide pin
26 fan hub
27 fan wheel
28 fan blade
29 outer ring
30 plane
31 potting material/potting compound
A axial direction
D motor axis/rotation axis
R radial direction

1. An electric motor in particular a radiator fan motor of a motor vehicle, having a motor support-and a stator fastened or attachable thereto, and an electric plug connection,
wherein the stator has a stator main body with radially oriented stator teeth and a stator or rotary field winding with winding ends,
wherein the plug connection is arranged, in particular clamped, between the stator main body and the motor support, and
wherein the winding ends of the stator or rotary field winding are directly connected to connection contacts of the plug connection for their in particular multi-phase current supply.

2. The electric motor according to claim 1, wherein the stator has an annular stator main body with a circumferential annular edge on which the plug connection is supported.

3. The electric motor according to claim 1, wherein the stator main body is surrounded, in particular encapsulated, with a plastic jacket.

4. The electric motor according to claim 1, wherein the stator main body, in particular at its or at another circumferential annular edge, has a number of joining contours which correspond to joining elements of the plug connection.

5. The electric motor according to claim 1, wherein the plug connection is provided with a potting material.

6. The electric motor according to claim 1, wherein the plug connection has a connection housing with the connection contacts for the winding ends of the stator or rotary field winding

7. The electric motor according to claim 6, wherein the plug connection has a housing cap for covering the connection housing and/or for securing the potting material or a potting material.

8. The electric motor according to claim 1, wherein the connection contacts of the plug connection are designed in the form of busbars, in particular as hook-shaped busbars.

9. The electric motor according to claim 1, wherein the plug connection has an in particular busbar-type ground or earthing contact, which is or can be brought into contact with the motor support.

10. The electric motor according to claim 1, wherein the plug connection is arranged or positioned at an acute angle relative to a plane parallel to the stator and/or to the motor support and/or at an angle of less than 90° and greater than 45° to a motor axis.
